(19) United States
(12) Patent Application Publication
(10) Pub. No.: US 2019/0315417 A1
(43) Pub. Date: Oct. 17, 2019

(54) Spare Tire Security Device

(71) Applicant: Horacio Miranda Verdugo, Hermosillo (MX)

(72) Inventor: Horacio Miranda Verdugo, Hermosillo (MX)

(21) Appl. No.: 16/469,613

(22) PCT Filed: Nov. 21, 2017
(86) PCT No.: PCT/MX17/00132

§ 371 Date: Jun. 13, 2019

(30) Foreign Application Priority Data
Dec. 16, 2016 (MX) MX/U/2016/000626

(51) Int. Cl. B62D 43/00; B62D 43/04

(52) U.S. Cl. CPC B62D 43/007; B62D 43/045

(57) ABSTRACT

A security device to safeguard spare tires with a rim is mounted on the underside of a vehicle with a cable attached to a pin on one end and a winch on the other end. The security device includes a flat disc base and a tube with several openings or holes. This device enters through the main spare tire rim opening, the base is supported on one side and the tube crosses it up to exit on the opposite side, thus protecting the cable that holds the tire. The cable and pin are introduced through the rim and they are introduced by the tube in such a way that the pin is inserted in a series of lateral holes in said tube. The cable and tire are adjusted by means of a winch. The cable that holds the tire is covered by the tube of the security device.

### INVENTION FIELD

As mentioned in the title of this descriptive report, this invention falls within the field of mechanics. Specifically pertaining to a spare tire lock designed to prevent the manipulation of the cable that secures the tire, thus making it theft-proof.

### SUBJECT MATTER OF THE INVENTION

This invention as mentioned in the title of this descriptive report refers to a spare tire lock that works by securing the cable by means of which the spare tire is mounted on automobiles that feature this mechanism, using for the theft protection of such spare tire in certain types of automobiles that have a safety device, which is comprised of at least one winch and a bolt or pin. The invention has a practical design since it is comprised by a single piece of easy installation.

The objective of such locking devise is to assure the automobile owner that the spare tire mounting mechanism is protected against theft. The locking device is of easy installation and difficult to remove without the proper tools.

### BACKGROUND

The spare tire purpose is the replacement of one of the tires in use in case one of them breaks down or malfunctions.

It is understandable that an automobile owner needs to be sure that in case of malfunction on any of the running tires there is a secure spare tire located in the same automobile. Said need has fostered the design of diverse mounting devices to prevent the access to the spare tire to prevent its theft. Next, some of the most relevant devices are briefly described.

Document U.S. Pat. No. 8,210,404 describes a device that prevents theft of a spare tire, which comprises a first cylinder having a certain length, an inner diameter and an outer diameter, a second cylinder having a certain length, an inner diameter and an outer diameter, a spring and a cable.

Document U.S. Pat. No. 6,079,932 describes a member for the support of a spare tie underneath a vehicle, which includes a platform section having a cutout area formed therein, where the cutout area has an upper cutout portion and a lower cutout portion; and an insert which fits and attaches into the cutout area of the support member.

Document U.S. Pat. No. 8,714,419 describes a spare tire lock, anti-theft system having a cable, a yoke and a sheath for the cable from the underside surface of the automobile to the yoke.

Document U.S. Pat. No. 6,505,488 describes a tire lock mounted on an opening in the vehicle frame in order to suspend a locking bar downward through an opening in the spare tire.

Document U.S. Pat. No. 7,487,952 describes a security device for securing spare tires and their rims, retracted by an elevation mechanism in the underside part of the automobile.

Document U.S. Pat. No. 8,936,427 describes a spare tire handling device mounted on a vehicle and adapted for moving a spare tire between a stored and an accessible position relative to the vehicle, which includes a winch and a flexible member.

Document U.S. Pat. No. 4,768,361 describes a device for locking the spare tire of a vehicle so that it can not be removed by unauthorized individuals. The device is made of two metallic assemblies, one of which is a rectangular tube and the other is a cylindrical plug.

Document KR1020130129847 describes a spare tire holder with cables. The present invention includes a winch, hollow pipe, and a clamping unit.

Document CN201110046152.1 describes a spare tire fixing device which comprises an elevation mechanism, a steel cable and a support mechanism, wherein the steel cable stretches into a frame one side of the elevation mechanism and is wound; the shrinkage and the extension of the steel cable can be carried out through a mechanical motion of internal parts of the winch mechanism so as to finish the rise and the drop of the spare tire.

Document KR1020060026127 describes a spare tire holder that is provided in order to install said spare tire in the lower part of the vehicle body, regardless of the mounting direction of the spare tire by forming a cable support extension part, thus preventing a front end of the cable from being bent. It comprises a cable unit, a support, and a wire stopper.

Document U.S. Pat. No. 5,426,963 describes a spare tire access lock for preventing the theft of spare tires on vehicles equipped with undercarriage mounted spare tires. The spare tire access hole lock is specially suited to be used on trucks that are equipped with an access hole in the bumper for facilitating the insertion of a tool necessary to release the spare tire from stowage.

Document ES2275823 describes a spare tire anti-theft device, externally mounted on the body of an automobile, which is locked from the inside of the vehicle covering a part of the totality of the rear face of the tire, characterized because the fixing bolt crosses one of the eccentric mounting perforation of the tire.

Document ES2011086 describes a spare tire anti-theft device of an automobile. It is comprised of a disc plate fastened to the inner side of the tire by means of screws that pass through the holes inside the tire, threaded to the plate itself.

Document MX2009011478 describes a mounting mechanism that allows rising or dropping a spare tire of a vehicle by means of a flexible cable actuated by a transmission system.

Document U.S. Pat. No. 631,821 describes a mechanism to handle spare tires, mounted on a vehicle, to displace the spare tire between a stored and accessible position with relation to the vehicle, and that is comprised by a rotary drum, and a support that can be connected in the other end of the cable.

Although the aforementioned solutions solve the securing and guarding of the spare tire, most of them require a complex set of components necessary to execute some kind of action, which makes the mounting and protection of it a complex activity.

To simplify said process, a device has been designed for easy manufacture and operation, thus accomplishing two objectives: to secure the spare tire to the vehicle frame and to block access of unauthorized users to the spare tire mounting mechanism while also retaining an easy operation for the owner and a compatibility with a variety of vehicle mounting mechanisms.

### BRIEF DESCRIPTION OF THE FIGURES

FIG. 1. Shows an isometric view of the spare tire security device.

FIG. 2. Shows a bottom view of the spare tire security device.

FIG. 3. Shows a front view of the spare tire security device.

FIG. 4. Shows a side view of the spare tire security device.

FIG. 5. Shows a front view of the spare tire security device, detailing a preferred position of the pin and cable that supports the pin.

FIG. 6. Shows a front view of the spare tire security device, detailing a preferred position of the pin and the cable that support it, and the relative position of the security device placed on the rim with the spare tire.

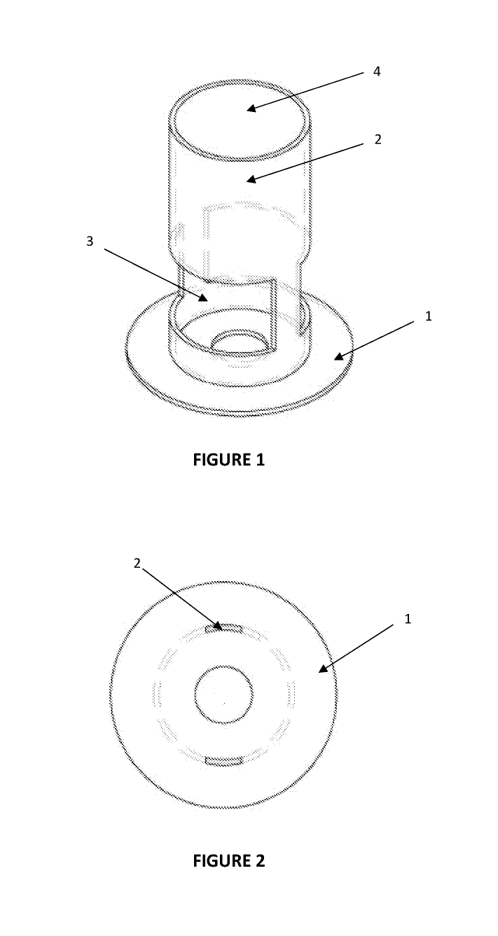

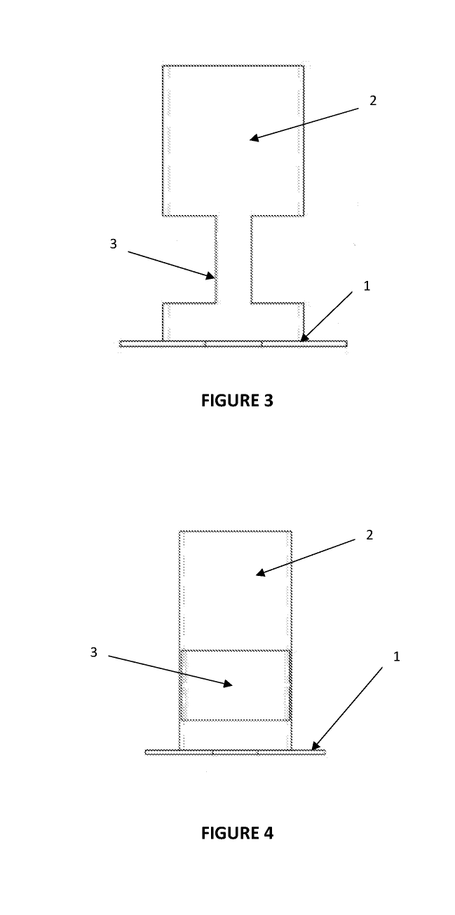

### DETAILED DESCRIPTION OF THE INVENTION

This descriptive report describes a theft prevention spare tire security device primarily suited for underside mounting systems with a wire cable winch on one end and a pin on the other end.

The security device is comprised of two parts: a base (1) and a tube (2) perpendicularly and concentrically attached to the base at one end, where the tube longitudinal axis coincides at the base center.

The base (1) is comprised by a flat plate whose size is larger than the rim center holes; and the tube's (2) dimensions are adequate so when the device is inserted through the rim of the spare tire, said tube can only be inserted but not the base

The tube (2) is hollow and works as a container and protector of the cable and it has to be installed in such a way that allows it to be inserted through the rim; it can be of any geometric profile as long as it covers the length of the cable and can be installed as previously described. The tube (2) has perforations on its lateral walls to form at least two lateral holes (3), where the pin (5) of the mounting device normally installed in the vehicle will be inserted.

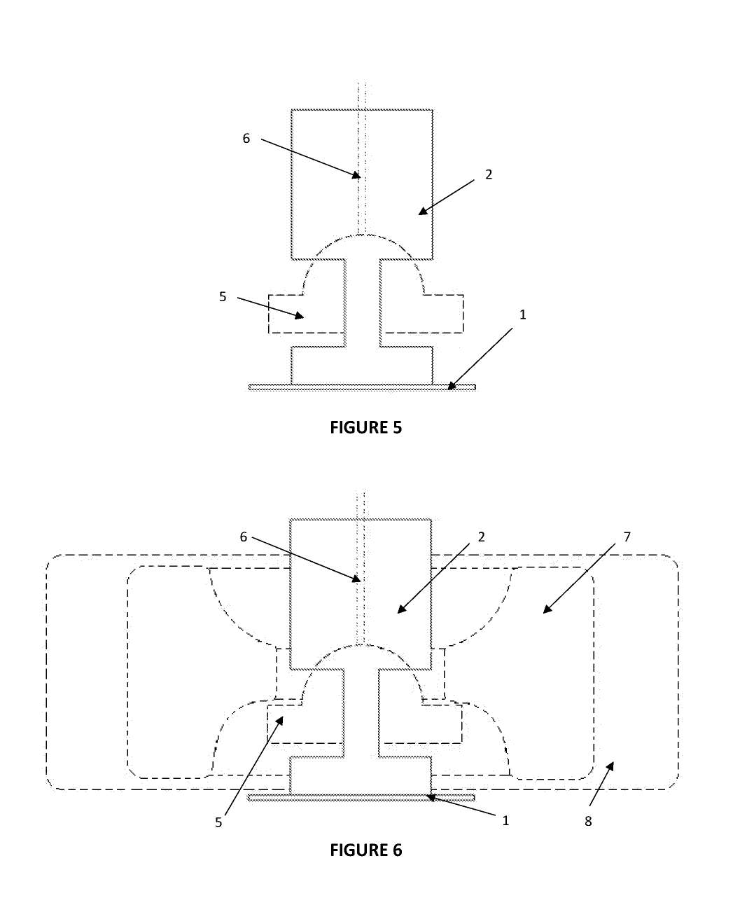

Said mounting device has at least one cable (6) and a pin (5) attached to said cable, where both elements are incorporated to a winch mechanism to hold the spare tire in place. The tube diameter should allow the pin and cable to be easily inserted and for the pin itself to be placed through both lateral holes (3). Thus, if the cable hangs underneath the car, the security device stays in place by means of the pin (FIG. 5).

To install the security device, the spare tire is supported from the mounting device by introducing the cable and pin through the rim (7) of the spare tire (8) until the cable itself goes through the rim. The pin and the cable are then introduced through the upper tube opening (4) and the pin is placed through both side openings (3) with each one of the ends (FIG. 5). Then, the security device is placed concentrically on one of the rim sides, and its tube (2) is inserted through said rim until the base (1) meets the rim while the tube (2) goes through it (FIG. 6).

This way, once the spare tire (7) is mounted with the winch mechanism, there is no access to the cable (6) which holds it since is guarded by the tube (2) of the security device; this makes it impossible to remove the spare tire by severing the wire cable. This requires the use of heavier tools and more time in order to disable or destroy the security device.

### Preferred Embodiments of the Invention

In a preferred embodiment of this invention, the base diameter can change depending on the diameter of the rim orifices; for example, the rim of a truck tire requires a base size bigger than the rim of a compact vehicle.

In another embodiment, the number and size of the side openings (3) can change to match the shape and size of the pin of the vehicle security system.

In another embodiment, the openings are situated from 0.5 cm to 5.0 cm to the base, in order to cover the cable from cutting tools when attempting to reach it by deflating the rubber tire and moving it upwards. Said cable is covered by the tube (2) hampering attempts to cut the cable.

In another embodiment, to facilitate manufacturing and operation, the tube (2) is recommended to have a cylindrical profile.

In another embodiment, the security device's materials should be made of a metal that facilitates soldering, while being tough enough to cover and protect the wire cable from being severed.

In another embodiment, the length of the tube (2) should be equal or smaller than the tire width in order to completely cover the access to the wire cable (6) that holds the spare tire (8) to the vehicle; such that the wire cable is covered by the security device on the case that the tire is deflated hampering attempts to cut the cable.

In another embodiment, the base has a center opening allowing spare cable through and a tube of the same diameter than the main tube (2) is joined to the underside of the base, working as an extension of the main tube and protecting the end of the wire cable extra length (6).

### Invention Advantages and Innovation

The invention presented on this descriptive report is a security device for spare tires mounted on a vehicle, and its design and characteristics present several benefits to the user. Through analysis of the Detailed Description, the Preferred Embodiments of the Invention and the presented Figures, the following advantages can be discerned.
The device has a simple design comprised of two components: a base (1) and a tube (2)
According to the embodiment of invention where the tube is cylindrical, the design is tougher, and the material used in its manufacture is minimized.
Since the security device is designed as a single piece and the pin can only be inserted in one specific way, which results on an easy installation process.
The toughness of the tube provides enough protection to make it a difficult process to sever the wire cable that mounts the tire to the vehicle.
The device itself is an accessory, adjustable to different vehicle types with different spare tire mounting methods.

1. A spare tire security device for a vehicle underside mounting mechanism including at least one wire cable and a pin, the security device comprising:
a base that includes a flat plate with a larger diameter than that of a rim orifice of the spare tire;
a tube with a smaller diameter than said rim orifice while having enough diameter to allow the pin and the cable to pass through it;
at least two lateral holes with enough diameter so the pin can be introduced into them; and
an upper hole with enough diameter so the cable and the pin can be introduced in the tube, and through it;
wherein the tube is attached to the base perpendicularly and concentrically by one of its ends and the upper hole is in the opposite side to the base, and the lateral holes are in the lateral walls of the tube, at a variable distance from the base.

2. A spare tire security device according to claim 1, wherein a variable distance from the base is 0.05 cm to 5.0 cm.

3. A spare tire security device according to claim 1, wherein the tube can have any geometric profile so long as its length covers the length of the cables that support the spare tire.

4. A spare tire security device according to claim 1, wherein the tube length is smaller or equal than the spare tire width.

5. A spare tire security device according to claim 1, wherein the tube side openings can be of any shape as long as the pin can be introduced easily on both.

6. A spare tire security device according to claim 1, wherein the base includes a center opening that allows for extra cable to go through and a second tube of the same diameter than the tube is attached to the underside of the base by one of its ends, working as an extension of the tube and protecting the end of the wire cable spare length.
